(19) United States
(12) Patent Application Publication
(10) Pub. No.: US 2021/0240047 A1
(43) Pub. Date: Aug. 5, 2021

(54) ELECTROCHROMIC COMPOUNDS

(71) Applicant: GENTEX CORPORATION, Zeeland, MI (US)

(72) Inventor: Punam Giri, Holland, MI (US)

(73) Assignee: GENTEX CORPORATION, Zeeland, MI (US)

(21) Appl. No.: 17/166,079

(22) Filed: Feb. 3, 2021

Related U.S. Application Data
(60) Provisional application No. 62/970,215, filed on Feb. 5, 2020.

(51) Int. Cl. G02F 1/1516; G02F 1/155; G02F 1/1503

(52) U.S. Cl. CPC G02F 1/1516; G02F 2202/02; G02F 1/1503; G02F 1/155

(57) ABSTRACT

An anodic redox species and a device using the chemical compound are disclosed. The device may comprise a first substrate, a second substrate, a first electrode, a second electrode, and/or an electrochromic medium. The second substrate may be disposed in a spaced apart relationship with the first substrate. The first electrode may be associated with the first substrate. The second electrode may likewise associated with the second substrate. The electrochromic medium may be disposed between the first and second electrodes. Further, the electrochromic medium may comprise at least one anodic redox species and at least one cathodic redox species. Lastly, the anodic redox species is a species of a formula whose compounds may have improved oxidation potentials.

### CROSS-REFERENCE TO RELATED APPLICATIONS

This application claims priority under 35 U.S.C. § 119(e) to U.S. Provisional Application No. 62/970,215 filed on Feb. 5, 2020, entitled “ELECTROCHROMIC COMPOUNDS,” the disclosure of which is hereby incorporated by reference in its entirety.

### FIELD OF INVENTION

The present disclosure is generally related to electrochromic devices. More particularly, it is related to redox compounds for use in an electrochromic medium of an electrochromic device.

### BACKGROUND OF INVENTION

Electrochromic devices have been well known for many years. When a sufficient electrical potential is applied across a pair of electrodes, an electrochromic medium, disposed between the electrodes, may become activated, changing its color and/or light transmissivity. Taking advantage of this, devices such as dimmable mirrors and windows have become increasingly popular in industries such as automotive and aviation.

However, electrochromic redox compounds often have low redox potentials. Further, functionalization of the redox compounds—which may be done for electrochromic color pre-determination—often results in a decrease of the already low redox potential. Low redox potentials present the problem of unwanted reduction and oxidation of the redox compounds. Accordingly, there is a need for improved redox compounds for use in electrochromic media.

### SUMMARY

In accordance with the present disclosure, the disadvantages and problems associated with redox compounds having low redox potentials have been substantially reduced or eliminated, particularly in the context of anodic redox species.

In accordance with one embodiment of the present disclosure, a device is disclosed. The device may comprise a first substrate, a second substrate, a first electrode, a second electrode, and/or an electrochromic medium. The second substrate may be disposed in a spaced apart relationship with the first substrate. The first electrode may be associated with the first substrate.

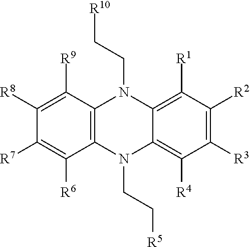

The second electrode may likewise be associated with the second substrate. The electrochromic medium may be disposed between the first and second electrodes. Further, the electrochromic medium may comprise at least one anodic redox species and at least one cathodic redox species. The anodic redox species may be of the formula below:
In the formula above, R⁵ and R¹⁰ may each be any poly substituted ammonium group. Additionally, R¹-R⁴ and R⁶-R⁹ may each individually one of: selected from the group consisting of: H, F, Cl, Br, I, CN, OR¹¹, NO₂, alkyl, alkoxy aryl, ammonium, fluoro alkyl, or amino, wherein R¹¹ is an H or alkyl group, or joining any adjacent R of R¹-R⁴ and R⁶-R⁹ to form at least one of a monocyclic, polycyclic, and heterocyclic group.

In some embodiments, the anodic redox species may also be of a second formula. The second may have a structure as follows:

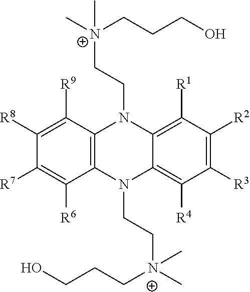

In some such embodiments, the anodic redox species may be N,N-(phenazine-5,10-diylbis(ethane-2,1-diyl))bis(3-hydroxy-N,N-dimethylpropan-1-aminium).

In other embodiments, the anodic redox species may be of a third formula. The third formula may have a structure as follows.

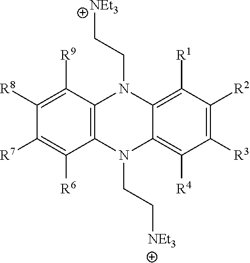

In some such embodiments, the anodic redox species may be 2,2′-(phenazine-5,10-diyl) bis(N,N,N-triethylethan-1-aminium).

In some embodiments, the anodic redox species may have a first oxidation potential. Further, the electrochromic medium may further comprise an electrochromic species having a first oxidation potential and a second oxidation potential. The first oxidation potential of the anodic redox species may be greater than the first oxidation potential of the electrochromic species and less than the second oxidation potential of the electrochromic species.

In accordance with another aspect of the present disclosure, a device is likewise disclosed. The device may comprise a first substrate, a second substrate, a first electrode, a second electrode, and/or an electrochromic medium. The second substrate is disposed in a spaced apart relationship with the first substrate. The first electrode may be associated with the first substrate. The second electrode may likewise associated with the second substrate. The electrochromic medium may be disposed in the chamber. Further, the electrochromic medium may comprise at least one anodic redox species and at least one cathodic redox species. Additionally, the anodic redox species may be of a formula below:

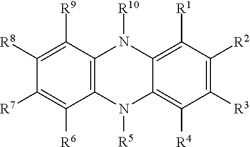

In the above formula, R⁵ and R¹⁰ may each be any alkyl group. Additionally, at least one of R¹-R⁴ and R⁶-R⁹ may each poly substituted ammonium groups, wherein the poly substituted ammonium group may be substituted with a combination selected from the group consisting of: H, F, Cl, Br, I, CN, OR¹¹, NO₂, alkyl, alkoxy aryl, or amino, wherein R¹¹ is an H or alkyl group. Further, each of the remaining of R¹-R⁴ and R⁶-R⁹ are selected from the group consisting of: H, F, Cl, Br, I, CN, OR¹¹, NO₂, alkyl, alkoxy aryl, ammonium, fluoroalkyl, or amino, wherein R¹¹ may be an H or alkyl group, or joining any adjacent R of R¹-R⁴ and R⁶-R⁹ to form at least one of a monocyclic, polycyclic, and heterocyclic group.

In some embodiments, two of R¹-R⁴ and R⁶-R⁹ are poly substituted ammonium groups. Further, in such an embodiment, one of the substituents of the poly substituted ammonium groups is a propyl alcohol group. Accordingly, in some embodiments, the anodic redox species may be: N²,N⁷-bis(3-hydroxypropyl)-N²,N²,N⁷,N⁷-tetramethyl-5,10-dineopentyl-5,10-dihydrophenazine-2,7-diaminium.

In other embodiments, at least one of R² and R⁷ are a poly substituted ammonium group, a cyano group, or a fluoroalkyl group. Further, in such an embodiment, the alkyl groups of R⁵ and R¹⁰ are a butyl alcohol. Accordingly, the anodic redox species may also be of the below formula:

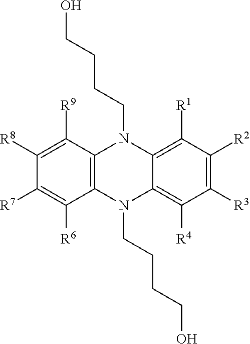

In some such embodiments, three of the substituents of the poly substituted ammonium group are alkyl groups. For example, the alkyl group may be any alkyl hydroxy chain, such as a propanol or hexanol. Accordingly, the anodic redox species may be 5,10-bis(4hydroxybutyl)-N,N,N-trimethyl-5,10-dihyrophenazin-2-aminium. In other such embodiments, at least one of R² and R⁷ are a cyano group. Accordingly, the anodic redox species may be 5,10-bis(4hydroxybutyl)-5,10-dihyrophenazin-2-carbonitrile. In yet other such embodiments, at least one of R² and R⁷ are a fluoroalkyl group. Accordingly, the anodic redox species may be 4,4′-(2-(trifluoromethyl)phenazine-5,10-diyl)bis(butan-1-ol).

In some embodiments, the anodic redox species may have a first oxidation potential. Further, the electrochromic medium may further comprise an electrochromic species having a first oxidation potential and a second oxidation potential. The first oxidation potential of the anodic redox species may be greater than the first oxidation potential of the electrochromic species and less than the second oxidation potential of the electrochromic species.

Some aspects of the present disclosure may have the advantage of anodic redox species with higher oxidation potentials. Compounds with higher oxidation potentials are less likely to experience unwanted oxidation. Further, the functionalization of the anodic species is often carried out to tune its absorbance spectrum for color pre-determination purposes. However, functionalization, particularly with electron donating groups, often decreases the oxidation potential. Accordingly, increased oxidation potentials likewise means functionalization for color pre-determination is more effectively enabled because the higher oxidation potential causes the associated potential drop to be more acceptable.

Additionally, the higher oxidation potentials enable them to be used as shunts—further enabling electrochromic devices of increased durability. Redox of a compound into its second reduction or oxidation state may yield unstable compounds and electrochromic medium degradation. However, when using a redox compound as a shunt in combination with another redox species having a first redox potential lower and a second redox potential higher than that of the redox shunt's first redox potential, the buffer will allow the redox species to undergo redox reactions in and out of its first redox state normally while conversely inhibiting the redox species from redox into its second redox state due to the shunt's lower redox potential and thus greater redox affinity.

### BRIEF DESCRIPTION OF FIGURES AND TABLES

In the drawings:

FIG. 1: Cross sectional schematic of an electrochromic device.

FIG. 2: Absorbance spectra of N,N-(phenazine-5,10-diylbis(ethane-2,1-diyl))bis(3-hydroxy-N,N-dimethylpropan-1-aminium); 5,10-dimethyl-5,10-dihydrophenazine; and 2,2′-(phenazine-5,10-diyl)bis(N,N,N-triethylethan-1-aminium.

Table 1a: Table illustrating effect of functionalization of anodic species on oxidation potentials, relative a standard hydrogen electrode.

Table 1b: Continuation of Table 1a, illustrating effect of functionalization of anodic species on oxidation potentials, relative a standard hydrogen electrode.

Table 2: Anodic species and corresponding oxidation potentials, relative a standard hydrogen electrode.

### DETAILED DESCRIPTION

Reference will now be made in detail to present preferred embodiments of the invention, examples of which are illustrated in the accompanying drawings. For the purposes of description herein, it is to be understood that the specific devices and processes illustrated in the attached drawings and described in the following specification are simply exemplary embodiments of the inventive concepts defined in the appended claims. Hence, specific characteristics relating the embodiments disclosed herein are not to be considered as limiting, unless the claims expressly state otherwise.

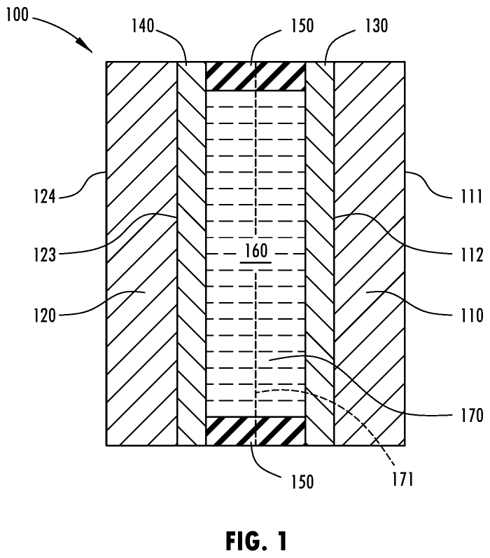

FIG. 1 is a cross sectional schematic representation of an electrochromic device 100. Electrochromic device 100 may comprise: a first substrate 110, a second substrate 120, a first electrode 130, a second electrode 140, a seal 150, and/or an electrochromic medium 160. Further, electrochromic device 100, for example, may be a mirror, a window, a display device, a contrast enhancement filter, and the like. Additionally, electrochromic device 100 may be operable between a substantially activated state and a substantially un-activated state. Operation between such states may correspond to a variable transmissivity

First substrate 110 may be substantially transparent in the visible and/or infrared regions of the electromagnetic spectrum. Further, first substrate 110 may have a first surface b and a second surface 112. First surface 111 and second surface 112 may be disposed opposite one another with second surface 112 disposed in a first direction relative first surface 110. The first direction may additionally be defined as substantially orthogonal first surface 111. Additionally, first substrate 110, for example, may be fabricated from any of a number of materials, such as alumino-silicate glass, such as Falcon commercially available from AGC; boroaluminosilicate (“BAS”) glass; polycarbonate, such as ProLens® polycarbonate, commercially available from Professional Plastics, which may be hard coated; polyethylene terephthalate, such as but not limited to Spallshield® CPET available from Kuraray®; soda lime glass, such as ultra-clear soda lime glass; float glass; natural and synthetic polymeric resins and plastics, such as polyethylene (e.g., low and/or high density), polyethylene terephthalate (PET), polyethylene naphthalate (PEN), polycarbonate (PC), polysulfone, acrylic polymers (e.g., poly(methyl methacrylate) (PMMA)), polymethacrylates, polyimides, polyamides (e.g., a cycloaliphatic diamine dodecanedioic acid polymer (i.e., Trogamid® CX7323)), epoxies, cyclic olefin polymers (COP) (e.g., Zeonor 1420R), cyclic olefin copolymers (COC) (e.g., Topas 6013S-04 or Mitsui Apel), polymethylpentene, cellulose ester based plastics (e.g., cellulose triacetate), transparent fluoropolymer, polyacrylonitrile; and/or combinations thereof. While particular substrate materials are disclosed, for illustrative purposes only, numerous other substrate materials are likewise suitable—so long as the materials are at least substantially transparent and exhibit appropriate physical properties such as strength and tolerance to conditions of the device's environment, such as ultra-violet light exposure from the sun, humidity, and temperature extremes.

Similarly, second substrate 120 may, have a third surface 123 and a fourth surface 124. Third surface 123 and fourth surface 124 may be disposed opposite one another with fourth surface 124 disposed in first direction 10 relative third surface 123. Additionally, second substrate 120 may be disposed in first direction 10 in a spaced apart relationship relative first substrate 110. Thus, third surface 123 may face second surface 112. In some embodiments, second substrate 120 may be substantially transparent in the visible and/or infrared regions. Accordingly, second substrate 120 may be comprised of the same or similar materials suitable for first substrate 110. In other embodiments, such as for a rearview mirror assembly, substantial transparency is not necessary. In such an embodiment, second substrate 120 may also be selected from substantially opaque and/or reflective materials. Accordingly, second substrate 120 may be reflective or comprise a reflective layer. Typical coatings for this type of reflector include chromium, rhodium, ruthenium, gold, silver, and combinations thereof.

First electrode 130 is an electrically conductive material. Further, first electrode 130 may be associated with second surface 112. Accordingly, first electrode 130 may be disposed on second surface 112. The electrically conductive material of first electrode 130 may be substantially transparent in the visible and/or infrared regions of the electromagnetic spectrum, bond reasonably well to first substrate 110, and/or be generally resistant to corrosion from materials of chamber material 170. For example, the electrically conductive material may be fabricated from a transparent conductive oxide (TCO), such as fluorine doped tin oxide (FTO), tin doped indium oxide (ITO), doped zinc oxide, indium zinc oxide, or other materials known in the art.

Second electrode 140 is, likewise, an electrically conductive material. Further, second electrode 140 is associated with third surface 123. Accordingly, second electrode 140 may be disposed on third surface 132. The electrically conductive material may be fabricated from the same or similar materials as first electrode 130. Accordingly, in some embodiments, second electrode 140 may be substantially transparent in the visible and/or infrared regions. In other embodiments, substantial transparency is not necessary. In such an embodiment, second electrode 140 may be selected from substantially opaque and/or reflective materials. Accordingly, second electrode 140 may be reflective or comprise a reflective layer. Typical coatings for this type of reflector include chromium, rhodium, ruthenium, gold, silver, and combinations thereof.

Seal 150 may be disposed in a peripheral manner to, at least in part, define a chamber 160. Chamber 160 is disposed between first substrate 110 and second substrate 120. Accordingly, chamber 160 may be defined by seal 150 in conjunction with at least two of: first substrate 110, second substrate 120, first electrode 130, and second electrode 140. In some embodiments, chamber 160 may, more specifically, be defined by seal 150, first electrode 130, and second electrode 140. Seal 150 may comprise any material capable of being bonded to the at least two of: first substrate 110, second substrate 120, first electrode 130, and second electrode 140, to in turn inhibit oxygen and/or moisture from entering chamber 170, as well as inhibit electrochromic medium 160 from inadvertently leaking out. Seal 150, for example, may include epoxies, urethanes, cyanoacrylates, acrylics, polyimides, polyamides, poly sulfides, phenoxy resin, polyolefins, and silicones.

Electrochromic medium 160 may be disposed in chamber 170. Accordingly, the electro-optic medium may be disposed between the first and second electrodes 130, 140. In some embodiments, the electrochromic medium 160 may be disposed in one or more layers associated with the first and/or second electrodes 130, 140. In other embodiments, electrochromic medium 160 may be dissolved in a solvent. Electrochromic medium 160 may comprise a plurality of redox species. Each redox species may be electro-active. Electro-active may mean the species may undergo a modification of its oxidation state upon exposure to a particular electrical potential difference. Accordingly, the electro-optic medium is operable between activated and un-activated states based, at least in part, on exposure to an electrical potential. The redox species may contain at least one anodic species and at least one cathodic species. Further, at least one of the redox species may be electrochromic. Accordingly, a cathodic and/or an anodic species may be electrochromic. The term “electrochromic” will be defined herein, regardless of its ordinary meaning, as a species that exhibits a change in its extinction coefficient at one or more wavelengths of the electromagnetic spectrum upon exposure to a particular electrical potential. Accordingly, upon application of an electric voltage or potential, the redox species is activated, producing a change in absorbance at one or more wavelengths of the electromagnetic spectrum. The change in absorbance may be in the visible, ultra-violet, infra-red, and/or near infra-red regions. In other words, the redox species may change color when an electrical potential is applied. Further, change in absorbance may correspond to a change in transmittance. The activation of the redox species may likewise correspond to an activated state of electrochromic medium 160 and/or electrochromic device 100, embodying the change is absorbance and/or transmittance.

In accordance with one aspect of the present disclosure, at least one of the anodic redox species may be a phenazine with the generally structure in Formula 1, as follows:

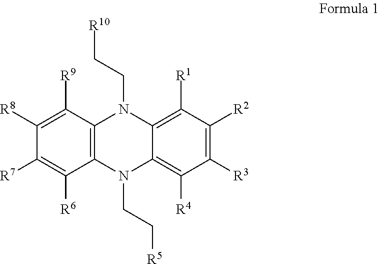

In Formula 1, shown above, R⁵ and R¹⁰ may each be any poly substituted ammonium group. The poly substituted ammonium group may be substituted with a combination of H, F, Cl, Br, I, CN, OR¹¹, NO₂, alkoxy aryl, or amino group, where R¹¹ is an H or alkyl group. Each of R¹-R⁴ and R⁶-R⁹ are individually H, F, Cl, Br, I, CN, OR¹¹, NO₂, alkyl, alkoxy aryl, amino group or may join any adjacent R of R¹-R⁴ and R⁶-R⁹ to form a monocyclic, polycyclic, or heterocyclic group, where R¹¹ is an H or alkyl group.

In some such embodiments of Formula 1, one of the substituents of the poly substituted ammonium group, may be a propyl alcohol group. In addition, the two remaining substituents of the poly substituted ammonium group may be methyl groups, yielding the general structure shown below in Formula 2:

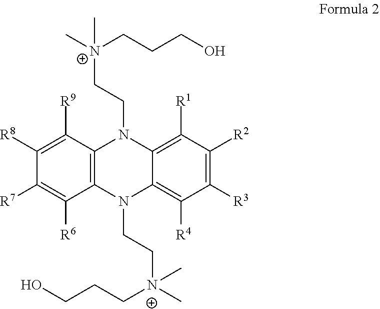

In some embodiments of Formula 2, each one of R¹-R⁴ and R⁶-R⁹ may be hydrogen. Accordingly, an exemplary compound of this embodiment is N,N-(phenazine-5,10-diylbis(ethane-2,1-diyl))bis(3-hydroxy-N,N-dimethylpropan-1-aminium), show in Formula 3 below:

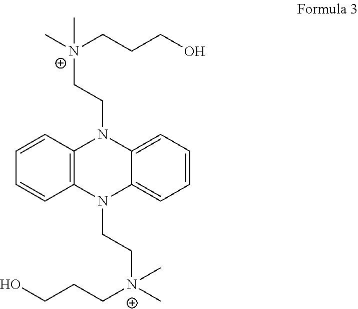 [SMILES: C[N+](C)(CCCO)CCN1c2ccccc2N(CC[N+](C)(C)CCCO)c2ccccc21]

In other embodiments of Formula 1, one or more of the poly substituted ammonium group may be an ethyl group. Accordingly, the poly substituted ammonium group may be triethyl ammonium, yielding Formula 4, shown below:

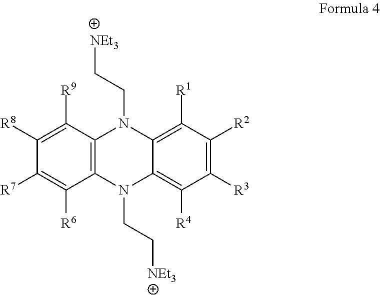

In some embodiments of Formula 4, R² and R⁷ may be a methyl group. Accordingly, an exemplary compound of this embodiment is (2-{2,7-dimethyl-10-[2-(triethylammonio)ethyl]phenazine-5-yl}ethyl)triethylazanium, as shown in Formula 5 below:

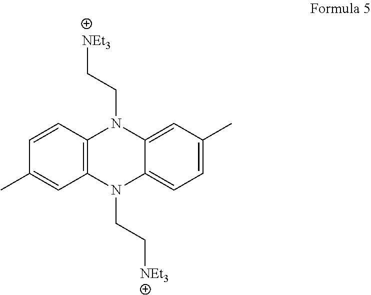

In other embodiments of Formula 4, each one of R¹-R⁴ and R⁶-R⁹ may be hydrogen. Accordingly, an exemplary compound of this embodiment is 2,2′-(phenazine-5,10-diyl) bis(N,N,N-triethylethan-1-aminium), as shown in Formula 6 below:

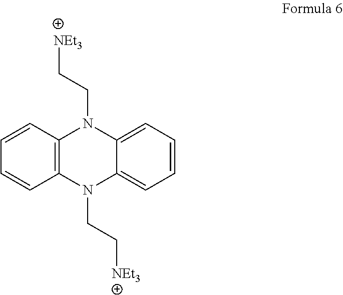

In accordance with another aspect of the present disclosure, at least one of the anodic species may be represented by Formula 7 shown below:

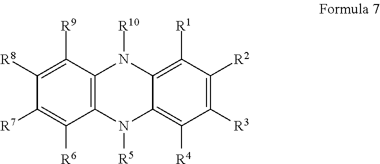

In Formula 7, shown above, R⁵ and R¹⁰ each may be any alkyl group. Further, one or two of R¹-R⁴ and R⁶-R⁹ are poly substituted ammonium groups. The poly substituted ammonium group may be substituted with a combination of H, F, Cl, Br, I, CN, OR¹¹, NO₂, alkyl, alkoxy aryl, ammonium, fluoroalkyl, or amino groups, where R¹¹ is an H or alkyl group. Each of the remaining of R¹-R⁴ and R⁶-R⁹ are individually a H, F, Cl, Br, I, CN, OR¹¹, NO₂, alkyl, alkoxy aryl, amino group or may join any adjacent R of R¹-R⁴ and R⁶-R⁹ to form a monocyclic, polycyclic, or heterocyclic group, where R¹¹ is an H or alkyl group.

In some embodiments of Formula 7, two of R¹-R⁴ and R⁶-R⁹ are poly substituted ammonium groups. Further, one of the substituents of the poly substituted ammonium groups may be a propyl alcohol group. In addition, the two remaining substituents of the poly substituted ammonium group may be methyl groups. An exemplary compound of such is N²,N⁷-bis(3-hydroxypropyl)-N²,N²,N⁷,N⁷-tetramethyl-5,10-dineopentyl-5,10-dihydrophenazine-2,7-diaminium, shown below:

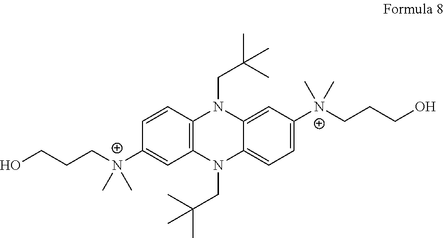 [SMILES: CC(C)(C)CN1c2ccc([N+](C)(C)CCCO)cc2N(CC(C)(C)C)c2ccc([N+](C)(C)CCCO)cc21]

In other embodiments of Formula 7, one or both of R² and R⁷ are further restricted to a poly substituted ammonium group, a cyano group, or a fluoroalkyl group. In some such embodiments, the alkyl groups of R⁵ and/or R¹⁰ may be a butyl alcohol. Further, the alcohol of the butyl alcohol may be at the primary carbon. Accordingly, the anodic species may be represented by Formula 9, shown below:

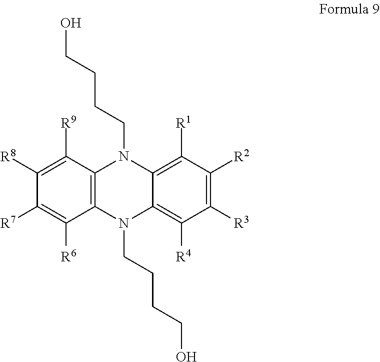

In some such embodiments of Formula 9, one, two, or three of the substituents of the poly substituted ammonium group may be an alkyl group, such as a methyl group. Accordingly, an exemplary compound of this embodiment is 5,10-bis(4-hydroxybutyl)-N,N,N-trimethyl-5,10-dihyrophenazin-2-aminium, shown in Formula 10 below:

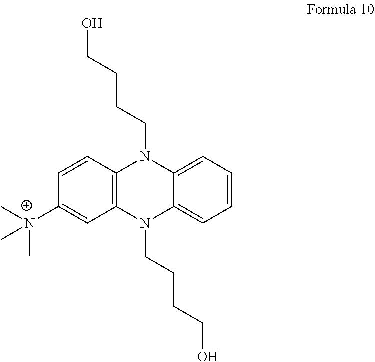 [SMILES: C[N+](C)(C)c1ccc2c(c1)N(CCCCO)c1ccccc1N2CCCCO]

In other such embodiments of Formula 9, at least one of R² and R⁷ may be a cyano group. Accordingly, an exemplary compound of this embodiment is 5,10-bis(4hydroxybutyl)-5,10-dihyrophenazin-2-carbonitrile, as shown in Formula 11 below:

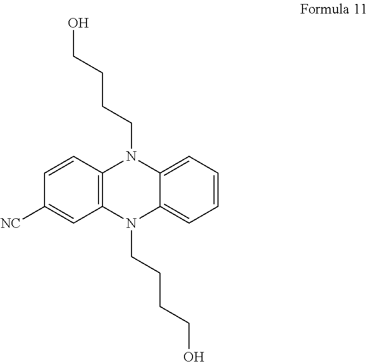 [SMILES: N#Cc1ccc2c(c1)N(CCCCO)c1ccccc1N2CCCCO]

In yet another such embodiments of Formula 9, one of R² and R⁷ may be a fluoroalkyl group. For example, the fluoroalkyl group may be a trifluoromethyl group. An exemplary compound of this embodiment is 4,4′-(2-(trifluoromethyl)phenazine-5,10-diyl)bis(butan-1-ol), as shown in Formula 12 below:

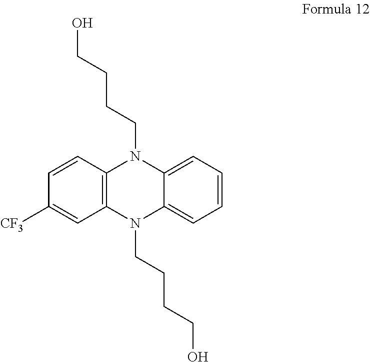 [SMILES: OCCCCN1c2ccccc2N(CCCCO)c2cc(C(F)(F)F)ccc21]

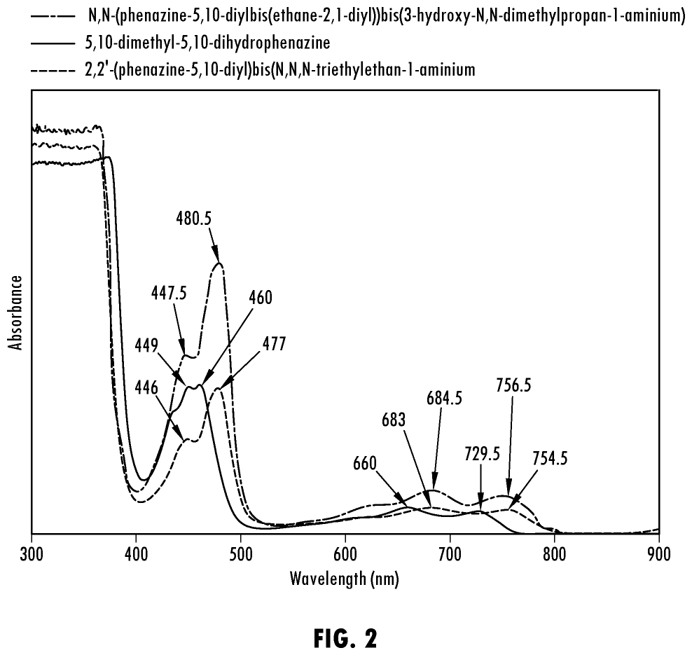

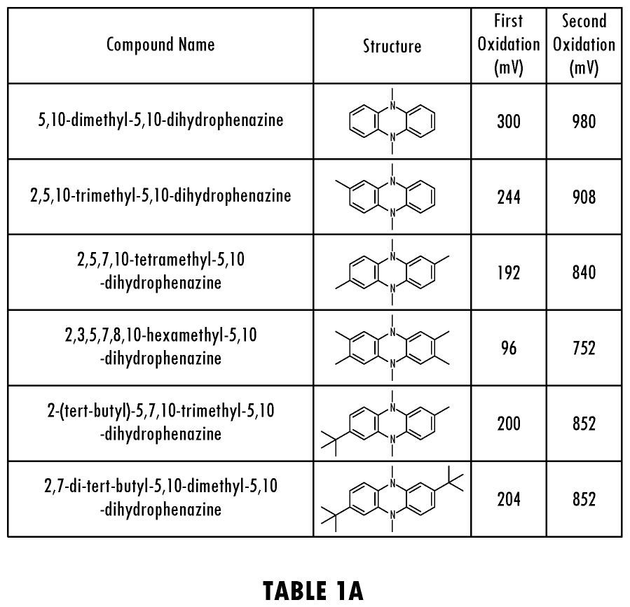

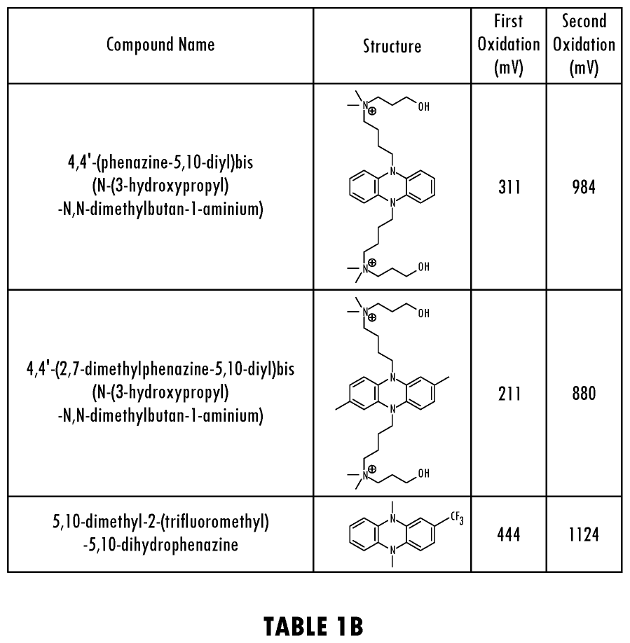

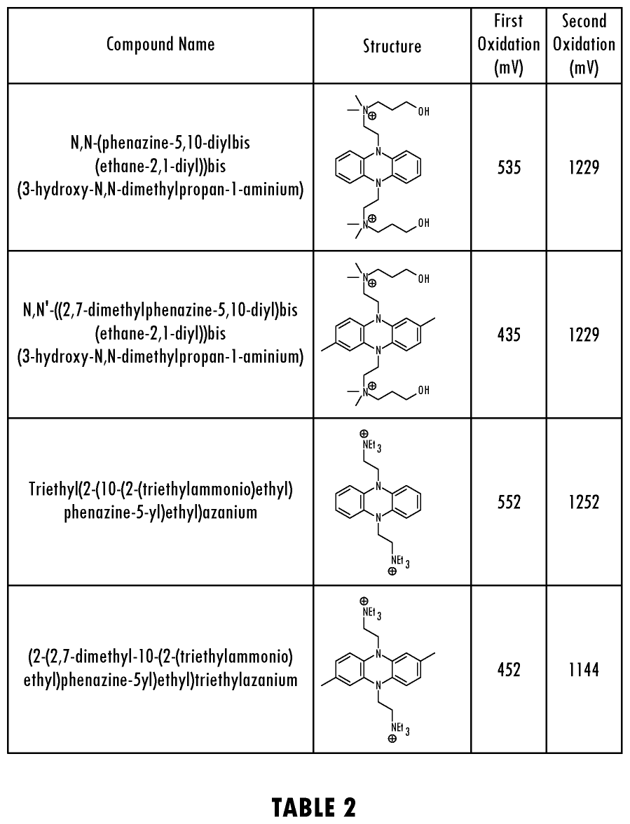

In accordance with another aspect of the present disclosure, in addition to at least one of the anodic redox species being of a formula represented above, the color change of the electrochromic medium may be pre-determined by selecting two or more redox species that are electrochromic. Further, the two or more redox species are selected such that their combined activated absorbance spectra are added together to produce a pre-determined spectrum. The pre-determined spectra may correspond to a vast variety of perceived colors and may be, for example, red, orange, yellow, green, blue, purple, or grey. As shown in FIG. 2, absorbance spectra of the anodic compounds: N,N-(phenazine-5,10-diylbis(ethane-2,1-diyl))bis(3-hydroxy-N,N-dimethylpropan-1-aminium), of Formula 3, and 2,2′-(phenazine-5,10-diyl)bis(N,N,N-triethylethan-1-aminium), of Formula 6, are plotted alongside an absorbance spectra of the known anodic compound 5,10-dimethyl-5,10-dihydrophenazine (“DMP”). N,N-(phenazine-5,10-diylbis(ethane-2,1-diyl))bis(3-hydroxy-N,N-dimethylpropan-1-aminium) is shown with a peak absorbance at or about 480.5 nm. Similarly, 2,2′-(phenazine-5,10-diyl)bis(N,N,N-triethylethan-1-aminium) is shown with a peak absorbance at or about 477 nm. Accordingly, these anodic compounds may be used with other redox species to produce a pre-determined spectrum.

In many applications, a color that is perceived as grey is preferred. Technically, grey is an achromatic degree of lightness between black and white, and although achromatic is defined as having zero saturation and therefore no hue, it should be construed broader in the context of the present invention to mean a color that is generally perceived as grey, and thus including embodiments with a little or moderate amount of color, when viewed by normal human eyesight.

In addition to pre-determining color via redox species selection, the concentrations of the electrochromic redox species may be selected to further enable color selection through device activation. In a stable device, the redox reaction must be balanced such that every electron that is removed through oxidation of an anodic species must be balanced by one electron that is accepted through reduction of a cathodic species. Thus, the total number of anodic species must equal the total number of cathodic species. Accordingly, by selecting three or more redox species, at least two of which are electrochromic, the concentrations of the electrochromic species may be selected to yield a different combined absorbance spectra, while still maintaining a balanced redox reaction. This color pre-determination through concentration is otherwise unachievable when only two redox species are selected since one would be anodic and the other cathodic, and because in maintenance of a balanced redox reaction, each species would be activated equally, resulting in a constant 1 to 1 blending of absorbance spectra.

Further, all of the electrochromic, anodic species may have redox potentials similar to one another and all of the electrochromic, cathodic species have redox potentials similar to one another. The similar redox potentials help generally maintain the pre-determined color throughout the transition between un-activated and activated electrochromic medium states. The redox potentials of the electrochromic anodic and/or electrochromic catholic species may be within 40 or 60 mV of each other.

In accordance with another aspect of the present disclosure, electrochromic medium 160 may contain a redox shunt compound represented by one of the above formulas 1-5 and one or more electrochromic species having a first redox potential less than that of the redox shunt.

In accordance with another aspect of the present disclosure, in addition to at least one of the anodic redox species being of a formula represented above, the electrochromic redox species may be sequestered in a polymer matrix or placed in chambered isolation. Typically, once the electrical potential is removed from the electrochromic medium, internal diffusion processes lead to continual self-erasing that results in de-activation of the electrochromic redox species. However, sequestration of the electrochromic redox species in a polymer matrix or chambered isolation within chamber 170 may result in a device configured to maintain the activated state for prolonged periods of time. The polymer matrices or isolated chambers inhibit the activated electrochromic redox species from readily undergoing an electron transfer process leading to de-activation. Accordingly, because the activated states are maintained upon removal of the electrical potential, the activated device may be a battery, a capacitor, or a supercapacitor.

For polymeric sequestration, the electrochromic redox species may be merely sequestered within the polymer matrix and separated from one another. Alternatively, the anodic and/or the cathodic species may be polymerized into the polymer matrix through functionalization of the anodic or cathodic species. For chambered isolation, electrochromic medium 160 further comprises an electrolyte and chamber 170 is further divided into sub-chambers by a separator 171. Seal 150 may also be divided into sub-sealing members by separator 171. Separator 171 may be comprised of any material that allows the movement of electrolyte between the sub-chambers but prevents or substantially inhibits the passage of activated redox species between the sub-chambers. For example, the separator may be an ion exchange membrane or a size exclusion membrane. It will be understood that the sequestering polymer and/or separator may be fabricated from any one of a number of materials or methods, including, for example, those disclosed in U.S. Pat. No. 9,964,828 entitled “Electrochromic Energy Storage Devices,” which is herein incorporated by reference.

Electrochromic device 100 is operable to dim. The first and second electrodes 130, 140 operate to deliver an electrical potential across electrochromic medium 160. Electrochromic medium 160 may be a medium of variable transmittance, and as such, when electrically activated, may darken and absorb light. Further, electrochromic medium 160 may be increasingly activated with an increasing electrical potential. The more light electrochromic medium 160 absorbs, the darker electrochromic device 100 may get. Alternatively, it is contemplated that electrochromic device 100 may work in reverse where the application of electrical voltage operates electrochromic medium 160 to vary in transmittance such that the solution absorbs less light.

In the above embodiments, electrochromic anodic redox species represented by Formulas 1-12 above, may generally have the advantageous characteristic of higher oxidation potentials. Compounds with higher oxidation potentials are less likely to experience unwanted oxidation. Further, the functionalization of the anodic species is often carried out to tune its absorbance spectrum for color pre-determination purposes. However, as illustrated in Table 1a-b, functionalization, particularly with electron donating groups, often decreases the oxidation potential. Accordingly, increased oxidation potentials likewise means functionalization for color pre-determination is more effectively enabled because the higher oxidation potential causes the associated potential drop to be more acceptable. Some specific embodiments of anodic redox species with higher oxidation potentials are illustrated in Table 2.

Additionally, the higher oxidation potentials of the above redox compounds enable them to be used as shunts—further enabling electrochromic devices of increased durability. Redox of a compound into its second reduction or oxidation state may yield unstable compounds and electrochromic medium degradation. However, when using a redox compound as a shunt in combination with another redox species having a first redox potential lower and a second redox potential higher than that of the redox shunt's first redox potential, the buffer will allow the redox species to undergo redox reactions in and out of its first redox state normally while conversely inhibiting the redox species from redox into its second redox state due to the shunt's lower redox potential and thus greater redox affinity.

Certain aspects of the present disclosure are illustrated in more detail in the following example. Unless otherwise specified, all concentrations are at room temperature (20-27 degrees Celsius).

### Example 1

### Synthesis of: N,N-(phenazine-5,10-diylbis(ethane-2,1-diyl))bis(3-hydroxy-N,N-dimethylpropan-1-aminium)

N,N-(phenazine-5,10-diylbis(ethane-2,1-diyl))bis(3-hydroxy-N,N-dimethylpropan-1-aminium) was made as follows:

Step 1: 90 g of phenazine, 113 g of sodium dithionite, 132 g of sodium carbonate, 220 ml of 2-bromo ethanol, 18 g of methyl tributyl ammonium chloride, 25 mL of water, and 1100 mL of acetonitrile were added to a three neck round bottom flask. The mixture was heated to 80° C. for 16 days. Then the reaction mixture was quenched with 1 L water and cooled to room temperature. The solid product was filtered and washed with water and cold ethanol to produce 133 g 2-[10-(2-hydroxylethyl)phenazine-5-yl]ethanol (98% yield).

Step 2: 3.7 g of 2-[10-(2-hydroxylethyl)phenazine-5-yl]ethanol from step 1, 30 mL dichloro ethane, 30 mL pyridine were added to a 250 mL three neck round bottom flask. The reaction mixture was then cooled to 5-0° C., to which methane sulfonyl chloride was slowly added via addition funnel. Following which, the reaction mixture was stirred at room temperature overnight. The reaction mixture was then cooled to 5-0° C. and quenched with 180 mL of water. Finally, 2-{10-[2-(methanesulfonyloxy)ethyl]phenazine-5-yl}ethyl methanesulfonate was isolated by filtration to give 4.0 g (68% yield).

Step 3: 4.0 g of 2-{10-[2-(methanesulfonyloxy)ethyl]phenazine-5-yl}ethyl methanesulfonate from step 2, 21.5 mL dimethyl amino propanol, and 100 mL acetonitrile were added to a 500 mL three neck round bottom flask. The reaction mixture was refluxed for seven days and then cooled to room temperature and filtered, yielding 4.5 g of (3-hydroxypropyl) [2-(10-{2-[(3-hydroxypropyl)dimethylammonio]ethyl}phenazine-5-yl)ethyl]dimethylazanium methosulfate salt (84% yield). The 4.5 g of (3-hydroxypropyl)[2-(10-{2-[(3-hydroxypropyl)dimethylammonio]ethyl}phenazine-5-yl)ethyl]dimethylazanium methosulfate salt was dissolved in 30 mL of methanol and heated to 60° C. To which 60 mL of 30% ammonium hexafluorophosphate solution was added and heated for 4 hours. After heating, 30 mL of water was added and the mixture was cooled to room temperature and then placed in an ice bath of 5-0° C. The solid was filtered and washed with water to give 5.0 g of N,N-(phenazine-5,10-diylbis(ethane-2,1-diyl))bis(3-hydroxy-N,N-dimethylpropan-1-aminium) (98% yield).

### Example 2

### Synthesis of: 2,2′-(phenazine-5,10-diyl)bis(N,N,N-triethylethan-1-aminium)

2,2′-(phenazine-5,10-diyl)bis(N,N,N-triethylethan-1-aminium) was made as follows:

Step 1: 57 g of charged 2-{10-[2-(methanesulfonyloxy)ethyl]phenazine-5-yl}ethyl methanesulfonate, 100 ml triethyl amine, and 600 ml acetonitrile were added to a three neck round bottom flask. The mixture was refluxed for ten days. Then the reaction mixture was cooled to room temperature. 300 ml acetone and 300 ml ethyl acetate were added to the room temperature mixture. After which, the reaction mixture was cooled to 0-5° C. The solid product was filtered and washed with acetone to produce 67 g bromide salt of desired product (80% yield).

Step 2: The bromide salt was converted to tetrafluoro borate salt by dissolving the bromide salt in a hot mixture of 75 ml of methanol, 300 ml of water, and 75 ml of 4 M sodium tetrafluoroborate solution. This reaction mixture was heated for 4 hours, then cooled to room temperature. The product was filtered and washed with water to produce 55 g tetrafluoroborate salt of desired product. The second metathesis was repeated as described above. The isolated solid was recrystallized from methanol to produce 36.0 g of 2,2′-(phenazine-5,10-diyl)bis(N,N,N-triethylethan-1-aminium).

In general, “substituted” refers to the instance in which one or more bonds to a carbon(s) or hydrogen(s) atom is replaced by one or more bonds, including double or triple bonds, or bonds to another substituent species. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

As used herein, “alkyl” groups include straight chain and branched alkyl groups having from 1 to about 20 carbon atoms, and typically from 1 to 12 carbons or, in some embodiments, from 1 to 8 carbon atoms. As employed herein, “alkyl groups” include cycloalkyl groups as defined below. Alkyl groups may be substituted or unsubstituted. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, and isopentyl groups.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 6, or 7. Cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to: 2,2-; 2,3-; 2,4-; 2,5-; or 2,6-disubstituted cyclohexyl groups or mono-, di-, or tri-substituted norbornyl or cycloheptyl groups, which may be substituted with, for example, alkyl, alkoxy, amino, thio, hydroxy, cyano, and/or halo groups.

As used herein, “aryl”, or “aromatic,” groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. The phrase “aryl groups” includes groups containing fused rings, such as fused aromatic-aliphatic ring systems (e.g., indanyl, tetrahydronaphthyl, and the like). Aryl groups may be substituted or unsubstituted.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

As used herein, the term “and/or,” when used in a list of two or more items, means that any one of the listed items can be employed by itself, or any combination of the two or more of the listed items can be employed. For example, if a composition is described as containing components A, B, and/or C, the composition can contain A alone; B alone; C alone; A and B in combination; A and C in combination; A and C in combination; B and C in combination; or A, B, and C in combination.

In this document, relational terms, such as “first,” “second,” and the like, are used solely to distinguish one entity or action from another entity or action, without necessarily requiring or implying any actual such relationship or order between such entities or actions.

The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

It is to be understood that although several embodiments are described in the present disclosure, numerous variations, alterations, transformations, and modifications may be understood by one skilled in the art, and the present disclosure is intended to encompass these variations, alterations, transformations, and modifications as within the scope of the appended claims, unless their language expressly states otherwise.

What is claimed is:

1. A device comprising:
a first substrate;
a second substrate disposed in a spaced apart relationship with the first substrate;
a first electrode associated with the first substrate;
a second electrode associated with the second substrate;
an electrochromic medium disposed between the first and second electrodes, wherein the electrochromic medium comprises at least one anodic redox species and at least one cathodic redox species, and the anodic redox species is of a first formula: 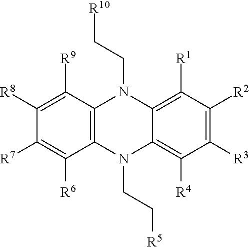
wherein:
R⁵ and R¹⁰ are each a poly substituted ammonium group, and
R¹-R⁴ and R⁶-R⁹ are each individually one of:
from the group consisting of: H, F, Cl, Br, I, CN, OR¹¹, NO₂, alkyl, alkoxy aryl, or amino, wherein R¹¹ is an H or alkyl group, and
joining any adjacent R of R¹-R⁴ and R⁶-R⁹ to form at least one of a monocyclic, polycyclic, and heterocyclic group.

2. The device of claim 1, wherein the anodic redox species is also of a second formula:

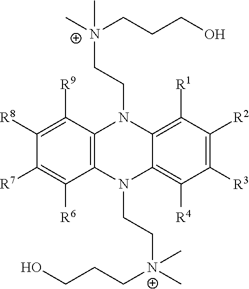

3. The device of claim 2, wherein the anodic redox species is N,N-(phenazine-5,10-diylbis(ethane-2,1-diyl))bis(3-hydroxy-N,N-dimethylpropan-1-aminium).

4. The device of claim 1, wherein the anodic redox species is also of a fourth formula:

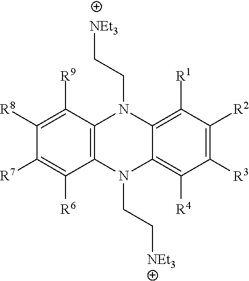

5. The device of claim 4, wherein the anodic redox species is 2,2′-(phenazine-5,10-diyl) bis(N,N,N-triethylethan-1-aminium).

6. The device of claim 1, wherein:
the anodic redox species has a first oxidation potential;
the electrochromic medium further comprises an electrochromic species having a first oxidation potential and a second oxidation potential; and
the first oxidation potential of the anodic redox species is greater than the first oxidation potential of the electrochromic species and less than the second oxidation potential of the electrochromic species.

7. A device comprising:
a first substrate;
a second substrate disposed in a spaced apart relationship with the first substrate;
a first electrode associated with the first substrate;
a second electrode associated with the second substrate;
an electrochromic medium disposed between the first and second electrodes; wherein the electrochromic medium comprises at least one anodic redox species and at least one cathodic redox species, and the anodic redox species is of a first formula: 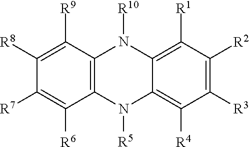
wherein:
R⁵ and R¹⁰ are each any alkyl group,
at least one of R¹-R⁴ and R⁶-R⁹ is a poly substituted ammonium group, wherein the poly substituted ammonium group is substituted with a combination selected from the group consisting of: H, F, Cl, Br, I, CN, OR¹¹, NO₂, alkyl, alkoxy aryl, ammonium, fluoroalkyl, or amino, wherein R¹¹ is an H or alkyl group, and
each of the remaining of R¹-R⁴ and R⁶-R⁹ are one of:
from the group consisting of: H, F, Cl, Br, I, CN, OR¹¹, NO₂, alkyl, alkoxy aryl, ammonium, fluoroalkyl, or amino, wherein R¹¹ is an H or alkyl group, and
joining any adjacent R of R¹-R⁴ and R⁶-R⁹ to form at least one of a monocyclic, polycyclic, and heterocyclic group.

8. The device of claim 7, wherein two of R¹-R⁴ and R⁶-R⁹ are poly substituted ammonium groups.

9. The device of claim 8, wherein one of the substituents of the poly substituted ammonium groups is a propyl alcohol group.

10. The device of claim 9, wherein the anodic redox species is also of a second formula: N²,N⁷-bis(3-hydroxypropyl)-N²,N²,N⁷,N⁷-tetramethyl-5,10-dineopentyl-5,10-dihydrophenazine-2,7-diaminium.

11. The device of claim 7, wherein at least one of R² and R⁷ are a poly substituted ammonium group, a cyano group, or a fluoroalkyl group.

12. The device of claim 11, wherein the alkyl groups of R⁵ and R¹⁰ are a butyl alcohol.

13. The device of claim 12, wherein the anodic redox species is also of a second formula:

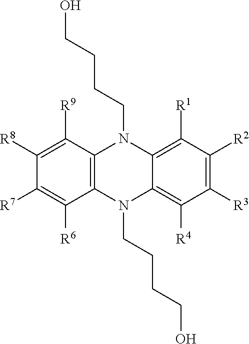

14. The device of claim 13, wherein three of the substituents of the poly substituted ammonium group are alkyl groups.

15. The device of claim 14, wherein the alkyl groups are a alkyl hydroxy chain.

16. The device of claim 13, wherein at least one of R² and R⁷ are a cyano group.

17. The device of claim 16, wherein the anodic redox species is 5,10-bis(4hydroxybutyl)-5,10-dihyrophenazin-2-carbonitrile.

18. The device of claim 13, wherein at least one of R² and R⁷ are a fluoroalkyl group.

19. The device of claim 18, wherein the anodic redox species is 4,4′-(2-(trifluoromethyl)phenazine-5,10-diyl)bis(butan-1-ol).

20. The device of claim 7, wherein:
the anodic redox species has a first oxidation potential;
the electrochromic medium further comprises an electrochromic species having a first oxidation potential and a second oxidation potential; and
the first oxidation potential of the anodic redox species is greater than the first oxidation potential of the electrochromic species and less than the second oxidation potential of the electrochromic species.
